(19) United States
(12) Patent Application Publication
(10) Pub. No.: US 2004/0140577 A1
(43) Pub. Date: Jul. 22, 2004

(54) Structured packing

(76) Inventors: Steven Ringo, Phillipsburg, NJ (US); Kevin McKeigue, Berkeley Heights, NJ (US)

Correspondence Address: Philip H. Von Neida, The BOC Group, Inc., Legal Services - Intellectual Property, 100 Mountain Ave., Murray Hill, NJ, 07974, US

(21) Appl. No.: 10/754,057

(22) Filed: Jan. 7, 2004

Related U.S. Application Data
(62) Division of application No. 10/037,642, filed on Dec. 21, 2001, now abandoned.

(51) Int. Cl. B01F 3/04

(52) U.S. Cl. 261/94; 261/DIG. 72

(57) ABSTRACT

A structured packing element comprising layers of corrugated and planar sheets is formed by winding at least one corrugated sheet and at least one planar sheet together in a spiral fashion. The resulting structured packing element may be used in a distillation column for air separation applications.

### FIELD OF THE INVENTION

The present invention relates generally to structured packings and applications to method of distillation, and more particularly, to spiral-wound structured packing elements and applications to cryogenic separation.

### BACKGROUND OF THE INVENTION

Structured packings have found widespread use in a variety of distillations including those involved in the separation of air into its component parts. Distillations are conducted within distillation columns filled with mass transfer elements to bring ascending vapor phases into intimate contact with descending liquid phases of mixtures to be separated. As the ascending phase rises and contacts the descending liquid phase, it becomes evermore enriched in the more volatile components of the mixture to be separated. At the same time, the descending liquid phase becomes ever more concentrated in the less volatile components of the mixture to be separated. In such fashion, systems of distillation columns can be used to separate various mixture components. For instance, in case of air separation, nitrogen is separated from oxygen in a double distillation column unit, in which the descending liquid phase inside the column becomes ever more concentrated in oxygen and the ascending gaseous phase becomes ever more concentrated in nitrogen. Argon is then separated from oxygen in an argon column that is attached to a lower pressure column of such a double distillation column unit.

Structured packings are widely used as mass transfer elements within distillation columns due to their low pressure drop characteristics. A structured packing typically includes many structured packing elements that are vertically stacked with respect to each other. Each structured packing element is made up of a number of corrugated sheets of material, in which the sheets are placed in a side by side relationship with the corrugations of adjacent sheets criss-crossing one another. In use, the liquid phase of the mixture to be separated is distributed to the top of the packing and spreads out throughout the packing as a descending film. The vapor phase of such a mixture rises through the corrugations contacting the liquid film as it descends.

There have been many attempts in the prior art to increase the efficiency of structured packings, that is, to decrease the height of packing equal to a theoretical plate (HETP). Obviously, the lower the height, the more efficient the packing. At the same time, a structured packing with a low HETP inherently has an increased pressure drop over less efficient packings. One such structured packing is disclosed in U.S. Pat. No. 4,597,916, issued on Jul. 1, 1986, in which the corrugated sheets are separated from one another by flat, perforated sheets that extend throughout the packing. It is believed that the flat perforated sheets of this prior packing increase efficiency by both providing additional interfacial area for vapor-liquid contact and by increasing turbulence in the vapor flow and therefore the degree of mixing between vapor and liquid phases.

Other approaches to improving the performance of structured packings have also been disclosed in U.S. Pat. No. 5,632,934 and EP patent 858,366B1, which involve modifying the configurations of corrugations close to the interfaces between adjacent structured packing elements. It is believed that such modifications lead to improved performance by reducing the pressure drop between adjacent packing elements.

Another structured packing has been disclosed in U.S. Pat. No. 6,280,819, which involves interposing one or more flat, planar members between the corrugated sheets such that at least the lowermost transverse edges of the planar members and the corrugated sheets are positioned proximal to one another. Using this improved packing element, turbulent vapor flow is inhibited and the capacity of the packing can be improved.

U.S. Pat. No. 4,186,159 discloses other packing elements made of a strip of foil-like material having a trickle surface provided with alternating smooth portions and finely-fluted portions. These packing elements may be formed from a number of corrugated plates, or may be spirally wound from a continuous strip to form an ordered packing, or may be in the form of cylinders to form a random packing.

However, there is still an ongoing need for alternative designs of structured packing elements for improving capacity without significant sacrifice in the separation efficiency, and vice versa.

### SUMMARY OF THE INVENTION

The present invention provides generally a structured packing element for use in distillation columns and a method of cryogenic separation using such a structured packing. According to one aspect of the invention, the structured packing element comprises a corrugated sheet and a planar sheet that are spirally wound together to form the packing element with the corrugated and planar sheets in substantial contact with each other, and at least one outermost horizontal edge of the planar sheet is positioned proximal to at least one horizontal edge of the corrugated sheet.

In one embodiment, a structured packing element comprises a corrugated sheet characterized by a top horizontal edge, a bottom horizontal edge and a height in a vertical direction, a top planar sheet and a bottom planar sheet that are spaced apart from each other in the vertical direction, with each of these planar sheets having respective heights that are less than the height of the corrugated sheet. The corrugated sheet and the two planar sheets are spirally wound together to form the packing element with layers of the corrugated sheet alternating with layers of the top and bottom planar sheets, and the top and bottom planar sheets have outermost horizontal edges that are proximally aligned respectively with top and bottom horizontal edges of the corrugated sheet.

Another aspect of the invention relates to a structured packing for use in a distillation column, with the structured packing containing two adjacent packing elements positioned vertically with respect to each other. Each of the two packing elements contains a corrugated sheet and a planar sheet that are spirally wound together, and the planar sheet has at least one outermost horizontal edge positioned proximal to at least one horizontal edge of the corrugated sheet.

Yet another aspect of the invention relates to a method of cryogenic separation, which comprises forming descending liquid and ascending gaseous phases of a fluid mixture within a distillation column, and contacting the descending liquid and ascending gaseous phases within a structured packing inside the column. The structured packing contains a series of packing elements, each of which comprises a corrugated sheet and a planar sheet that are wound together, resulting in the corrugated and planar sheets being in substantial contact with each other. Furthermore, at least one outermost horizontal edge of the planar sheet is positioned proximal to at least one horizontal edge of the corrugated sheet.

### BRIEF DESCRIPTION OF THE DRAWINGS

While the specification concludes with claims distinctly pointing out the subject matter that the applicants regard as their invention, it is believed the invention would be better understood when taken in connection with the accompanying drawings in which:

FIG. 1 is a schematic perspective view of a structured packing element according to the present invention;

FIG. 2 is a schematic illustration of the structured packing element of FIG. 1 viewed from one end;

FIG. 3A is a schematic cross-sectional view of the structured packing element along a vertical plane 3-3′ of FIG. 2;

FIG. 3B is a schematic cross-sectional view of another embodiment of a structured packing element;

FIG. 4A is a schematic perspective view of another embodiment of a structured packing element;

FIG. 4B is a schematic cross-sectional view of the structured packing element of FIG. 4A along a vertical plane;

FIG. 5 is a schematic illustration of a planar sheet that can be used to form packing elements of the present invention;

FIG. 6 is a schematic illustration of a corrugated sheet that can be used to form packing elements of the present invention;

FIGS. 7A-B are schematic illustrations of two embodiments of a structured packing element comprising two corrugated sheets;

FIG. 8 is a schematic cross-sectional view of yet another embodiment of a structured packing element containing a center member;

FIGS. 9A-B are schematic illustrations of alternative embodiments of a packing element containing a fastening member; and

FIGS. 10A-C are schematic side view illustrations of different arrangements of packing elements to form structured packings according to the present invention.

### DETAILED DESCRIPTION

The present invention relates to structured packing elements that are formed by winding together one or more corrugated sheets and at least one non-corrugated planar sheet, and to methods of distillation using structured packings formed from these packing elements.

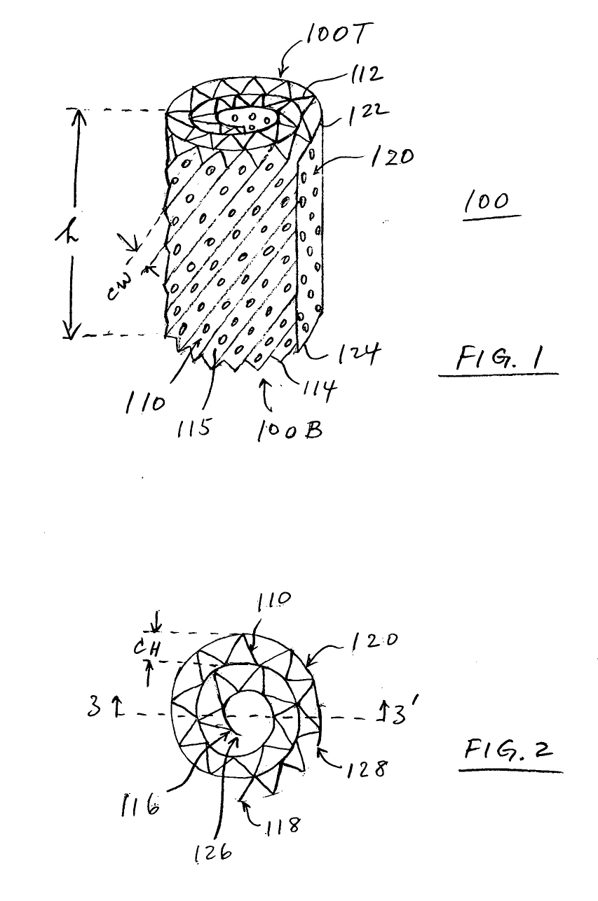

FIG. 1 illustrates a schematic perspective view of a structured packing element 100 according to one embodiment of the present invention. The packing element 100 comprises a corrugated sheet 110 and a planar sheet 120 that are wound together in a spiral fashion. The sheets can be held in place by various techniques, e.g., by circumferential bands or sleeves which exert a compressive force on the assembly, or by pins or rods traversing the assembly at various points, or other appropriate fastening means as readily ascertained by one skilled in the art. Both the corrugated sheet 110 and the planar sheet 120 are generally rectangular in shape, although other shapes may also be used. The packing element 100 is substantially cylindrical. In one embodiment, the corrugated sheet 110 and the planar sheet 120 have approximately the same height (h) as each other, and they are arranged such that the top and bottom horizontal edges 112 and 114 of the corrugated sheet are proximally aligned with the top and bottom horizontal edges 122 and 124 of the planar sheet, respectively.

When the packing element 100 is used as part of a structured packing for a distillation column, it is placed in a vertical orientation inside the column, with adjacent packing elements (not shown) positioned above its top end 100T and its bottom end 1001B. The distillation column may comprise one or more structured packing beds each comprising several packing elements 100. Corrugations 115 on the corrugated sheet 110 are typically inclined at an angle to the vertical, e.g., 30°, 45° or 60°, and act as channels for descending liquid or ascending vapor inside the distillation column. The corrugations 115 may be characterized by a corrugation width CW, which is the distance measured perpendicularly to the corrugation direction from peak to peak (or trough to trough).

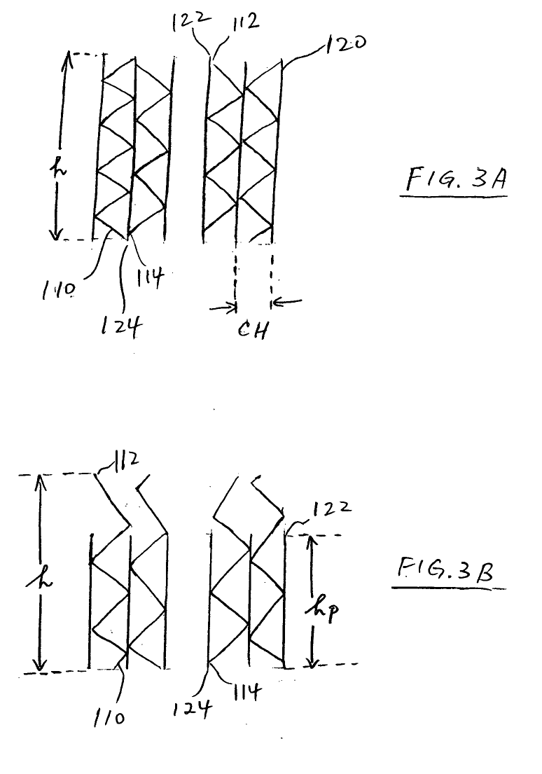

FIG. 2 is a schematic illustration of the structured packing element 100 as viewed from one end. The packing element 100 may be formed by any appropriate fabrication methods, such as by winding the inner end 116 of the corrugated sheet 110 and the inner end 126 of the planar sheet 120 together around a mandrel or hub (not shown). Other methods of forming the winding are also acceptable. The continuous winding of the corrugated and planar sheets 110 and 120 results in a packing element with multiple alternating corrugated and planar layers. Unlike a conventional structured packing element comprising a series of rectangular corrugated sheets, corrugations 115 corresponding to adjacent layers of corrugated sheet 110 do not criss-cross each other in this embodiment of the spiral wound packing element 100. The lack of interaction between vapor streams moving in different directions means that such a structured packing will have reduced turbulence, thus resulting in a lower pressure drop. The inner end 126 of the planar sheet 120 is shown as being used on the “inside” of the spiral-wound packing element 100, but in practice, either the corrugated sheet 110 or the planar sheet 120 may be the inside sheet.

For optimal efficiency or operation, the packing element 100 should preferably be formed such that adjacent planar and corrugated layers are in substantial contact with each other—i.e., the peaks and troughs of the corrugated sheet 110 are in physical contact with the planar sheet 120 throughout much of the spiral wound packing element 100. Thus, the layers of the planar sheet 120 are separated from each other by a distance about equal to a corrugation height CH of the corrugations 115, which is given by the perpendicular distance between a peak and a trough. The spiral winding of the structured packing element should be tight enough to keep adjacent corrugated and planar layers to be substantially in contact with each other during use in distillation columns.

FIG. 3A is a schematic cross-sectional view of the packing element 100 taken along the direction 3-3′ of FIG. 2. The packing element 100 is characterized by a height “h” in the vertical direction, which is equal to the height of the corrugated sheet 110. As illustrated in FIG. 3A, the planar sheet 120 also has a height that is about equal to that of the corrugated sheet 110 such that their respective horizontal edges are proximally aligned with each other. That is, the top horizontal edge 112 of the corrugated sheet 110 is positioned to be at least close to, or proximal to the top horizontal edge 122 of the planar sheet 120. Similarly, the bottom horizontal edge 114 of the corrugated sheet 110 and the bottom horizontal edge 124 of the planar sheet 120 are also proximal to, or approximately aligned with each other. It is understood, however, that some misalignment between the horizontal edges, e.g., on the order of about 5 mm, is acceptable.

In another embodiment illustrated in FIG. 3B, the planar sheet 120 may have a height hₚ that is less than the height h of the corrugated sheet 110. In this case, at least one of the respective horizontal edges (i.e., either top or bottom edges) of the corrugated and the planar sheets 110 and 120 should be proximally aligned with each other. However, it is preferable that the bottom horizontal edge 114 of the corrugated sheet 110 and the bottom horizontal edge 124 of the planar sheet 120 be approximately aligned with each other. Although not wishing to be bound to theory, such a bottom edge alignment is believed to result in better performance by allowing more efficient drainage of the descending liquid in the packing element by providing increased liquid contact areas at the interface with an adjacent packing element.

The corrugated sheet 110 is usually perforated, while the planar sheet 120 may be either perforated or non-perforated. For example, a non-perforated planar sheet 120 may be used if the planar sheet 120 has a height that is less than about two-thirds of the height of the corrugated sheet 110. These perforations help prevent or minimize transverse vapor and liquid flows while allowing pressure equalization across planar sheet 120 and corrugated sheet 110. Alternatively, a non-perforated planar sheet 120 may also be used if the planar sheet 120 has other shapes or designs that provide sufficient “open” areas to achieve pressure equalization across the structured packing element 100.

In another embodiment, the planar sheet 120 may have surface texture embossed or applied. These surface texture may include, for example, fluting, dimpling, among others known to one skilled in the art. It is believed that such optional surface texture may help provide increased surface areas for liquid-vapor contact, and facilitate the spread of liquid on the surface.

The corrugated sheet 110 and the planar sheet 120 are generally made of the same material, and different metals may be used, depending on the requirements of various distillation applications. For cryogenic applications, for example, aluminum, copper, or their alloys, stainless steel, and combinations thereof, are preferred materials. The planar sheet 120 may be fabricated from a material selected from the group consisting of metal, mesh, gauze and combinations thereof, either with or without perforations.

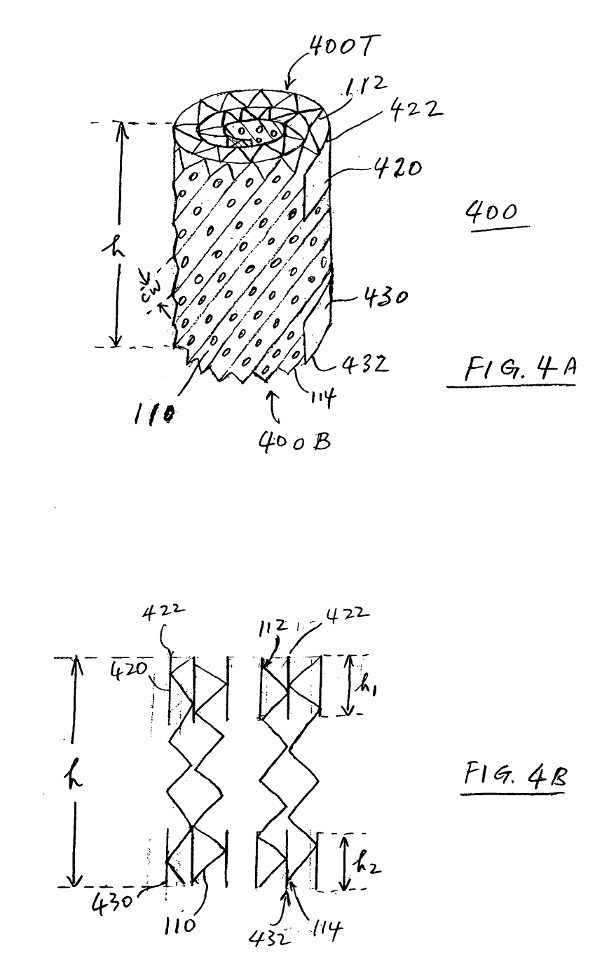

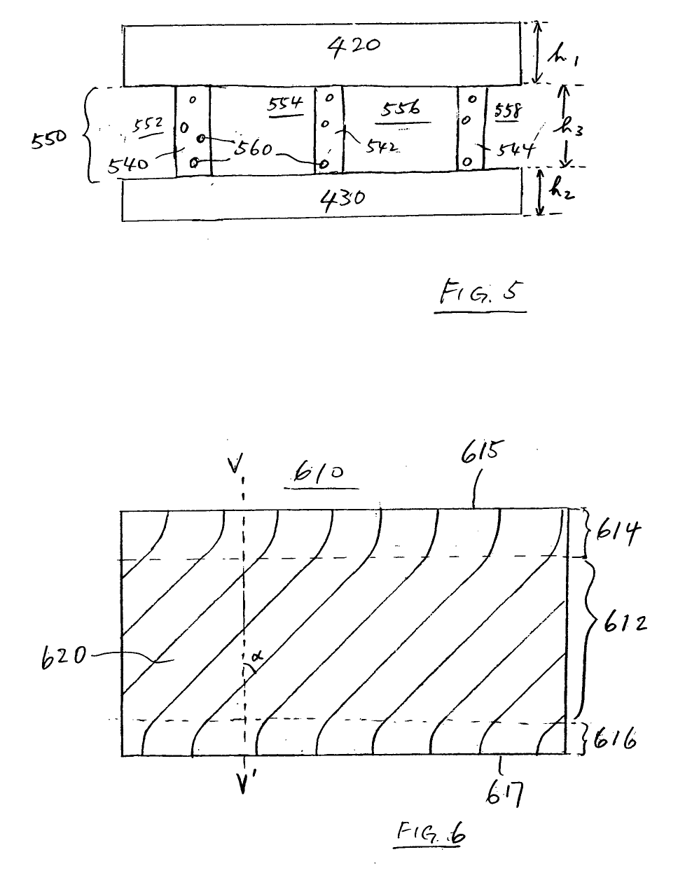

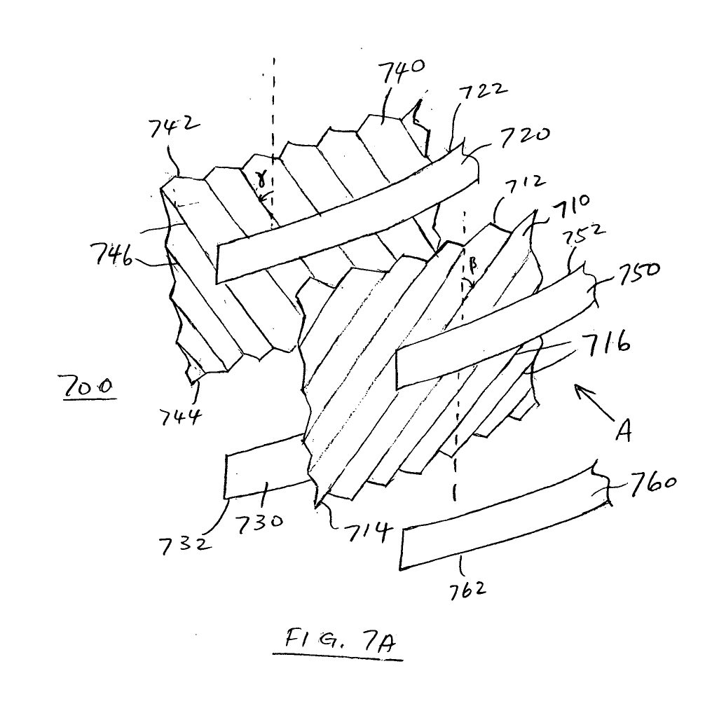

FIG. 4A illustrates another embodiment of the present invention in which a structured packing element 400 is formed by winding two planar strips or sheets 420, 430 together with one corrugated sheet 110 in a spiral fashion similar to that described for the structured packing element 100. FIG. 4B is a schematic cross-sectional view of the structured packing element 400 taken along a vertical plane.

In this embodiment, one planar strip 420 is positioned towards the top end 400T of the structured packing element 400, while the other planar strip 430 is positioned towards the bottom end 400B of the structured packing element 400. Each of the planar strips 420 and 430 has an outer and an inner horizontal edge. Both planar strips are positioned such that the outermost horizontal edge 422 of the planar strip 420 is proximally aligned with the top horizontal edge 112 of the corrugated sheet 110, and the outermost horizontal edge 432 of the planar strip 430 is proximally aligned with the bottom horizontal edge 114 of the corrugated sheet 110.

The height of the structured packing element 400 is given by the height h of the corrugated sheet 110. In general, each of the planar strips 420 and 430 may have heights h, and h₂ that are less than h, and h₁ and h₂ may be different from each other. In one embodiment, the planar strips 420 and 430 each has a height that is at least about two times that of the corrugation width CW of the corrugation sheet 110. Furthermore, the planar strips 420 and 430 may be perforated or non-perforated. For example, if the planar strips 420 and 430 have a combined height (h₁ plus h₂) that is less than about two-thirds of h, then perforations are generally not necessary for these planar strips.

In another configuration, the two planar strips 420 and 430 may also be connected to each other by one or more connecting members. This is illustrated in FIG. 5, which shows the two planar strips 420 and 430 and connecting members 540, 542 and 544 (with heights h₃) in their “unwound” form. Although three connecting members are shown in FIG. 5, it is understood that other combinations of connecting members are also acceptable. In general, the connecting members 540, 542 and 544 may be attached to the planar strips 420 and 430 using any suitable techniques such as welding, brazing or riveting, among others. Furthermore, one or more of these connecting members 540, 542 and 544 may be provided with perforations 560, and the connecting members may also be provided in the form of wires or rods. Alternatively, this configuration can also be fabricated as an integral, single planar sheet with the desired geometric layout.

The embodiment illustrated in FIG. 5, whether fabricated from separate planar strips 420 and 430 with one or more adjoining connecting members or from a single planar sheet, can provide additional advantages in ease of fabrication and assembly of the packing element. For example, by fabricating the planar sheet such that its height, or the total height of the planar strips 420, 430 and the connecting members (i.e., h₁+h₂+h₃), is about equal to that of the corrugated sheet, one can avoid the need for separate alignments of the top and bottom horizontal edges of the two planar strips with respect to the corrugated sheet.

In addition, the embodiment of FIG. 5 may be designed to approximate the hydraulic characteristics of the two separate planar strips 420 and 430. This can be achieved, for example, by providing a middle portion 550 (generally defined as the area between the upper and lower planar strips 420 and 430) with a relatively large fraction thereof being open area, e.g., at least about 20%, and preferably at least about 50% of the total area of the middle portion 550. In this illustration, the open area of the middle portion 550 includes areas 552, 554, 556 and 558, as well as areas provided by perforations that may be present on one or more of the connecting members. The top and bottom planar strips form a top and bottom portion respectively. As used herein, the term “open area percent” for any given portion of the planar sheet refers to the percentage of the total open area of the given portion relative to the total area of that portion.

In general, many other corrugated sheets with different geometries may be used in forming packing elements illustrated herein. These different geometries may include, for example, varying angles of inclinations or corrugation heights for the corrugations, especially towards the bottom or top portions of a corrugated sheet. FIG. 6 illustrates one example of a corrugated sheet 610 having such a modified end geometry. Such a corrugated sheet 610 is used in a MELLAPAKPLUS™ 752.Y packing, which is available from Sulzer Chemtech Ltd., Winterthur, Switzerland. In its “unwound” form, the corrugated sheet 610 is substantially rectangular. Details of a MELLAPAKPLUS packing have been disclosed in a PCT International Patent Application, WO 97/16247, and in European Patent Specification EP 858,366B1, both of which are incorporated herein by reference. Unlike corrugations 115 of the corrugated sheet 110, which have essentially constant angles of inclination throughout the entire corrugated sheet 110, corrugations 620 have angles of inclination a (with respect to a vertical axis VV′) that vary in different parts of the corrugated sheet 610.

For example, the corrugated sheet 610 can be considered as comprising a middle portion 612 and two terminal portions 614 and 616 (or upper and lower portions respectively). The corrugations 620 can generally be characterized by angles of inclination a with respect to the vertical direction. In the middle portion 612, corrugations 620 are disposed at a uniform or substantially constant angle that is less than 90°, e.g., 45° or 60°. This angle of inclination decreases progressively within the upper and lower portions 614 and 616 of the corrugated sheet 610 such that corrugations 620 intersect an upper horizontal edge 615 and a lower horizontal edge 617 of the corrugated sheet 610 substantially perpendicularly, i.e., with angle of inclination a close to about 0°.

In addition, corrugations 620 may also intersect the upper and/or lower horizontal edges 615 and 617 at any angle ranging from about 0° to about 10° from vertical. By providing the angle of inclination being close to vertical at the top or bottom edges of the corrugated sheet 610, a reduced pressure drop can be achieved within a structured packing comprising such packing elements. Although a corrugated sheet such as that illustrated in FIG. 6 can generally be used in forming different embodiments of spiral-wound packing elements, it is particularly well-suited to certain structured packing configurations that will be discussed below. In other variations, corrugations 612 may also have angles of inclination that vary only within either the upper portion 614 or lower portion 616 of the corrugated sheet 610.

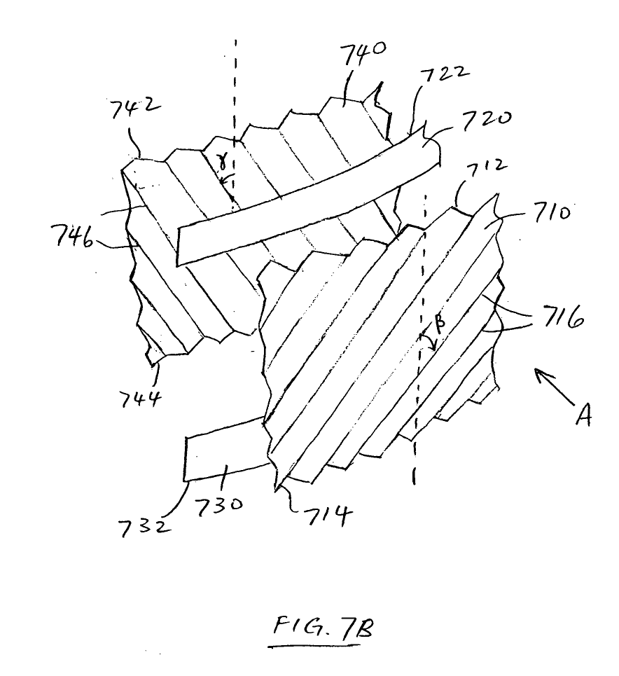

Although in each of the above embodiments, only one corrugated sheet is shown to be wound together with one or more planar sheets or strips to form a structured packing element, it is understood that one or more corrugated sheets may also be used. FIG. 7A illustrates a partial exploded view of a structured packing element 700 formed by winding two corrugated sheets 710 and 740 and four planar strips 720, 730, 750 and 760 together.

Prior to being wound together, planar strips 720 and 730 are positioned between the corrugated sheets 710 and 740, while planar strips 750 and 760 are positioned adjacent to the corrugated sheet 710. When these planar strips and corrugated sheets are wound together, the resulting structured packing element comprises alternating layers of corrugated sheets and pairs of planar strips, with planar strips 750 and 760 also positioned between corrugated sheets 710 and 740. Preferably, each of the planar strips has at least one outermost horizontal edge aligned with corresponding edges of the adjacent corrugated sheets. That is, the top edges 722 and 752 of planar strips 720 and 750 are proximally aligned with top edges 712 and 742 of the corrugated sheets 710 and 740; and the bottom edges 732 and 762 of planar strips 730 and 760 are proximally aligned with bottom edges 714 and 744 of the corrugated sheets.

Furthermore, each of corrugated sheets 710 and 740 is arranged such that their respective sets of corrugations 716 and 746 criss-cross each other. In this illustration, when viewed from one side of the structured packing element 700, e.g., along the direction of the arrow A, the set of corrugations 716 in the corrugated sheet 710 are inclined at an acute angle β measured in a clockwise sense with respect to the vertical direction (indicated by dashed lines); while the set of corrugations 746 in the corrugated sheet 740 are inclined at an acute angle γ measured in a counter-clockwise sense with respect to the vertical.

With corrugations from adjacent corrugated layers arranged in this criss-cross manner, additional mixing of the liquid and vapor streams can be achieved in a middle portion of the packing element 700 (i.e., between the top planar strips 720 and 750 and the bottom planar strips 730 and 760). This is expected to result in an enhanced separation efficiency, and thus, a lower height equivalent theoretical plate (HETP) than the embodiment illustrated in FIG. 4A.

However, the presence of this criss-crossed corrugation directions in a packing element may also result in an increased pressure drop at an interface between two adjacent (vertically stacked) packing elements due to the abrupt change in corrugation directions between the adjacent packing elements. Corrugated sheets with end geometry modifications such as that illustrated in FIG. 6 will be especially beneficial in the embodiment of FIG. 7. The use of corrugated sheets 710 and 740 with end geometry modifications is expected to result in a packing element with reduced pressure drop (due to minimal change in vapor flow direction at the packing element interface), while enhanced separation efficiency can be obtained through the criss-cross arrangement of the corrugated sheets.

It is understood that different variations or combinations of corrugated and planar sheets may also be used to achieve other embodiments with criss-crossing corrugations. For example, instead of two separate corrugated sheets as illustrated in FIG. 7A, a single corrugated sheet may be folded about a vertical axis (not shown) such that the folded two halves correspond essentially to the two corrugated sheets 710 and 740 with criss-crossed corrugations. In another alternative embodiment shown in FIG. 7B, a structured packing may also be formed by using only two planar strips 720 and 730 positioned between corrugated sheets 710 and 740—i.e., by omitting planar strips 750 and 760 of FIG. 7A. In the resulting packing element, certain layers of corrugated sheets 710 and 740 will have the planar strips 720 and 730 positioned between them, while other layers of corrugated sheets 710 and 740 will be positioned adjacent to each other, without any planar strips in between.

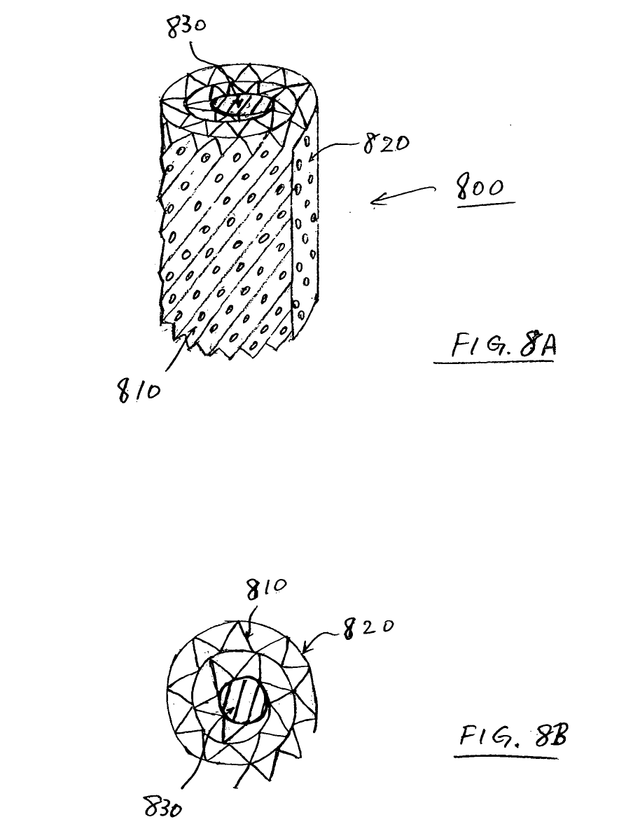

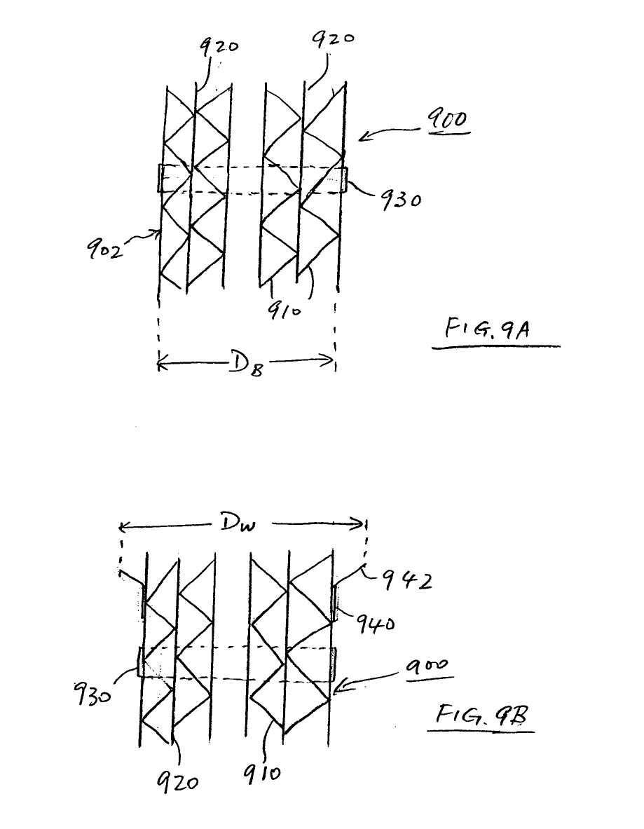

FIG. 8A is a schematic perspective view of yet another embodiment of a structured packing element according to the present invention. The structured packing element 800 is similar to that illustrated in FIG. 1, having a corrugated sheet 810 and a planar sheet 820 wound together, except that a center member 830 is provided towards the center of the packing element 800. This center member 830, which is preferably substantially cylindrical, may be designed to serve different functions to aid in the fabrication, installation or performance of the packing element 800.

For example, the center member 830 may be provided with attachment points for the corrugated and/or planar sheets, and may serve as a mandrel or hub for winding the sheets to form the packing element 800. The center member 830 may be configured for coupling to lifting tools used for lifting or inserting the packing element 800 into a distillation column. Alternatively, alignment of packing element 800 with adjacent packing elements (not shown) can be facilitated by using the center member 830 as an alignment aid.

These various functions of the center member 830 may be achieved with different combinations of designs and structures that include, for example, a solid cylinder or a tubular structure, which may further be provided with channels, perforations, slots and so on. Aside from serving various mechanical functions (e.g., attachment to or winding of planar or corrugated sheets), the center member 830 may also incorporate designs for improving process performance. For example, a solid cylindrical design is appropriate in applications where it is desirable to impede or minimize vapor or liquid flow near the center of the column. If a certain pattern of vapor or liquid flow is desired near the center of the column, channels or perforations may be provided in the center member 830 to properly direct or control the vapor and/or liquid flows. In another variation, a tubular structure may serve as a convenient mandrel piece to facilitate fabricating the structured packing element 800, and still provide a hollow center portion for insertion of a centering or alignment tool during installation. Different dimensions of the center member 830 may be selected to suit specific column or application needs, and the center member 830 may generally be used in any of the structured packing elements disclosed herein.

Structured packing elements of the present invention can be fabricated using a variety of techniques known to one skilled in the art. For example, planar sheets, with or without perforations, are available commercially and corrugated sheets can be fabricated from planar sheets using conventional methods, and existing machinery used in sheet metal works may be adapted for winding the corrugated and planar sheets together to form the structured packing elements.

Structured packing elements of the present invention can be used to form structured packing beds for use in a variety of distillation columns, including chemical distillations or cryogenic distillation columns for air separation applications, and various advantages can be achieved over conventional packing elements. For example, spiral-wound structured packing elements can provide reduced fabrication and installation costs compared to those requiring an array of corrugated and planar sheets. The fabrication of a spiral-wound structured packing element is simplified by avoiding the need to provide a large number of individual corrugated and planar sheets that require alignment with respect to each other.

Fabrication and installation of such a packing element within a distillation column is facilitated because a spiral-wound packing element can readily be custom-fitted to any column diameter. For optimal operation, the space between the packing element and the column wall should be minimized in order to avoid significant portions of the vapor or liquid streams from bypassing the packing element. With a conventional packing element made from rectangular sheets, many precise cuts are often required to provide proper matching to a cylindrical column. In the case of the spiral wound packing element, the diameter can easily be adjusted simply by providing the proper number of windings of the corrugated and planar sheets. Such custom-fitting may be achieved in different manners.

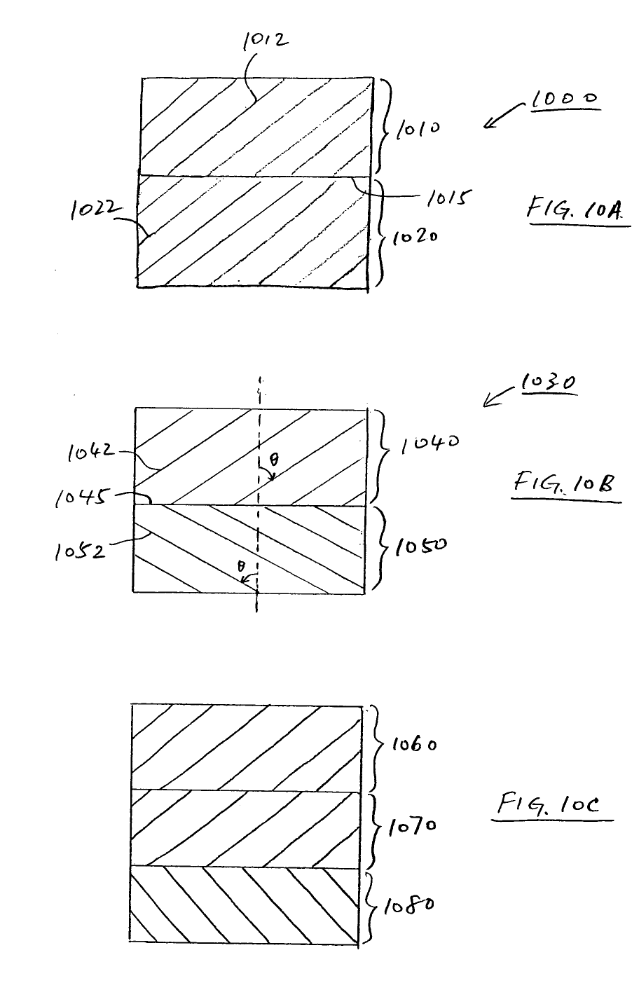

FIG. 9A is a schematic illustration of a cross-sectional view (through a vertical plane) of one embodiment of a spiral-wound packing element 900, in which a fastening member 930 is provided at one or more appropriate locations of the packing element 900. The fastening member 930 is used primarily to secure or bind the corrugated and planar sheets 910 and 920 of the structured packing element 900 together prior to installation in the distillation column. Different designs may be used for the fastening member 930 including, for example, a sleeve or band around the perimeter 902 of the packing element 900, a wire extending across the cross-section of the packing element 900, or a vertically-oriented wire, pin or clip which binds the outermost layer of the spiral winding to one or more inner layers of the spiral winding, among others. By binding the packing element 900 to a diameter (D_{B}) that is smaller that of the distillation column (thus avoiding excessive friction between the packing element 900 and the wall of the column), the packing element 900 can be inserted into the column with relative ease during installation. While not required, any of the fastening members can also be provided with a convenient means for removal of the fastening member, which will allow the fastening member to be removed from the spiral-wound packing after the packing has been placed in the desired location within the column shell.

Furthermore, the packing element 900 is preferably spiral-wound and bound sufficiently tightly such that there is a certain degree of “spring tension” stored in its bound form. Once the packing element 900 is positioned in a desired location inside the column, the fastening member 930 may be removed or otherwise severed to release the compressive force exerted around the packing element 900. The corrugated and planar sheets 910 and 920 are thus allowed to expand outwards towards the wall of the column. With sufficient spring tension, the packing element 900 may be expanded against the column wall, thus allowing a custom-fit to the column diameter.

Alternatively, the packing element 900 may be used in conjunction with one or more “wiper bands”, which are strips of metal bands or mesh typically attached around the circumference or perimeter of a conventional packing element to provide a tight seal between the packing element and the column wall. FIG. 9B illustrates a wiper band 940 with tab portions 942 folded away from the packing element 900 such that the overall diameter (D_{W}) is greater than that of the internal diameter of the column wall. Since the tab portions 942 are flexible to a certain degree, the overall diameter of the wiper band 940 can be “self-adjusted” to match the column wall diameter. When the fastening member 930 is removed or severed after the packing element 900 is positioned inside the column, the spring tension of the packing element 900 provides additional outward forces on the tab portions 942 of the wiper band 940, resulting in improved sealing with the column wall. To fully realize the benefits of this feature, the wiper band itself can be designed as an overlapping ring or other shape which allows the wiper band to also exhibit spring tension. Thus, undesirable spaces between the wiper band 940 (or the packing element 900 in FIG. 9A) and the column wall can be minimized through this custom-fitting design, resulting in improved separation efficiency in the distillation process.

As previously mentioned, a conventional packing element comprises an array of rectangular corrugated sheets having corrugations with constant angles of inclination that criss-cross each other. When the packing elements are stacked vertically to form a structured packing, the corrugations in adjacent elements are angled with respect to each other, resulting in a relatively abrupt change of vapor flow direction, and thus, a corresponding pressure drop at the interface between two packing elements.

According to one aspect of the invention, a structured packing can be formed from different arrangements of spiral-wound packing elements that are stacked vertically with respect to each other. FIG. 10A is a schematic side view illustration of a portion of a structured packing 1000 comprising two adjacent packing elements 1010 and 1020. These two packing elements are arranged such that their respective corrugations 1012 and 1022 are maintained at substantially the same angle with respect to each other at the interface 1015 of the packing elements 1010 and 1020. Such a configuration is expected to result in a decreased pressure drop compared to a conventional packing, because the change in direction of the corrugations, and thus, the change in direction of the vapor flow from one packing element to the next is minimized. In this embodiment, there is no criss-crossing of the corrugations within each of the packing elements 1010 and 1020.

FIG. 10B illustrates another embodiment of a portion of a structured packing 1030 in which adjacent packing elements 1040 and 1050 are arranged with respective corrugations in opposite directions. That is, corrugations 1042 of the packing element 1040 are inclined at an acute angle θ measured in a clockwise direction from vertical, while corrugations 1052 of the packing element 1050 are inclined at an acute angle θ measured in a counter-clockwise direction from vertical. In this context, the packing element 1040 may be characterized as having a “right-handed” corrugation direction—e.g., with the right thumb pointing in a vertical (up) direction, the other fingers will indicate substantially the direction of the corrugations, which causes the vapor to flow in a substantially helical path up the column. Likewise, the packing element 1050 may be considered as having a left-handed corrugation direction.

Other packing elements (not shown) may similarly be arranged adjacent to packing elements 1040 and 1050 with alternating or opposite “handedness” for corrugations of adjacent elements. Although this embodiment may result in a higher pressure drop at the interface 1045 between packing elements 1040 and 1050 (due to a larger change in corrugation directions) compared with that shown in FIG. 10A, it is expected that an increase in separation efficiency, i.e., a reduced HETP, can be achieved. In such an embodiment, the use of corrugated sheets with end geometry modifications such as that shown in FIG. 6 is expected to be especially beneficial, since the pressure drop can be minimized at the interface 1045.

In yet another embodiment, a structured packing may be formed from a combination of packing elements arranged such that some adjacent elements may have the same corrugation handedness, while others may have opposite handedness. Such an example is shown in FIG. 10C, in which adjacent packing elements 1060 and 1070 have the same handedness in their corrugation directions, while packing elements 1070 and 1080 have corrugations with opposite handedness. Such an arrangement, or other variations thereof, may be useful in optimizing certain desired characteristics within a separation column. In general, higher capacity and reduced pressure drop can be expected from adjacent packing elements having the same corrugation handedness, while a higher separation efficiency can be achieved (at the expense of increased pressure drop) with adjacent packing elements having opposite handedness. Combinations of these various arrangements may be used in different portions of a distillation column to optimize or tailor the process to specific application needs.

It should be appreciated that different aspects of packing elements of the present invention contribute to a variety of improvements in the air separation process. For example, the alternating layers of planar and corrugated sheets provide both increased surface area for vapor-liquid contact within each packing element and a preferred hydraulic environment resulting in a higher capacity packing compared to one formed from a spiral-wound corrugated sheet alone. Proximal edge alignment of the planar and corrugated sheets provides for improved liquid drainage due to increased surfaces for liquid contact. Furthermore, different arrangements of packing elements can be used to achieve desired tradeoffs between pressure drop and separation efficiency within the structured packing, thus allowing optimization of column designs to suit specific application needs. Various designs that facilitate the fabrication and installation of the packing elements also contribute to a more economical and robust air separation process by allowing customization to various column diameters.

While the present invention has been described with reference to several embodiments, other changes, additions and omissions as will occur to those skilled in the art may be made without departing from the spirit and scope of the present invention.

What is claimed is:

1. A structured packing element for use in a distillation column comprising:
a corrugated sheet;
a planar sheet;
wherein said corrugated sheet and said planar sheet are spirally wound together to form said packing element with said corrugated sheet and said planar sheet in substantial contact with each other, and at least one outermost horizontal edge of said planar sheet is positioned proximal to at least one horizontal edge of said corrugated sheet.

2. The structured packing element of claim 1, wherein said planar sheet is perforated.

3. The structured packing element of claim 1, wherein said planar sheet is non-perforated.

4. The structured packing element of claim 3, wherein said structured packing is characterized by a height in a vertical direction that is given by a height of said corrugated sheet, said planar sheet has a height less than about two-thirds of said height of said corrugated sheet.

5. The structured packing element of claim 1, wherein said at least one horizontal edge of said corrugated sheet is a bottom edge.

6. The structured packing element of claim 1, wherein said corrugated sheet and said planar sheet are respectively made of a material selected from the group consisting of metal, mesh, gauze, and combinations thereof.

7. The structured packing element of claim 1, comprising a top planar sheet and a bottom planar sheet spaced apart from each other in a vertical direction, said top planar sheet having a top horizontal edge aligned proximal to a top horizontal edge of said corrugated sheet, and said bottom planar sheet having a bottom horizontal edge aligned proximal to a bottom horizontal edge of said corrugated sheet.

8. The structured packing element of claim 7, wherein said corrugated sheet is perforated, said top and bottom planar sheets are non-perforated, and said top and bottom planar sheets have a combined height of less than about two-thirds of a height of said corrugated sheet.

9. The structured packing element of claim 1, wherein said planar sheet further comprises surface texture designed for increasing surface area of said planar sheet.

10. The structured packing element of claim 1 comprising two corrugated sheets, said two corrugated sheets having respective corrugations characterized by angles of inclination from vertical, and said two corrugated sheets are arranged such that said respective corrugations are oriented in a criss-cross manner.

11. The structured packing element of claim 10, wherein each of said two corrugated sheets has a top portion, a middle portion and a bottom portion, and said corrugations in said middle portion have angles of inclination that are larger than angles of inclinations of said corrugations in at least one of said top and bottom portions.

12. The structured packing element of claim 1, wherein said planar sheet comprises a top portion, a middle portion and a bottom portion, and said middle portion has an open area percent that is higher than open area percents of said top and bottom portions.

13. The structured packing element of claim 1, further comprising a center member located at a center of said structured packing element.

14. A structured packing element for use in a distillation column comprising:
a corrugated sheet characterized by a top horizontal edge, a bottom horizontal edge and a height in a vertical direction;
a top planar sheet and a bottom planar sheet spaced apart from each other in said vertical direction, each of said top and bottom planar sheets having respective heights that are less than said height of said corrugated sheet;
wherein said corrugated sheet and said top and bottom planar sheets are spirally wound together to form said packing element with layers of said corrugated sheet alternating with layers of said top and bottom planar sheets, and said top and bottom planar sheets having outermost horizontal edges that are proximally aligned respectively with said top and bottom horizontal edges of said corrugated sheet.

15. The structured packing element of claim 14, further comprising a fastening member binding said spiral wound packing element to a first diameter, said fastening member being releasable to allow said spiral wound packing element to expand outwards to a second diameter when released.

16. A structured packing for use in a distillation column, said structured packing comprising two adjacent packing elements positioned vertically with respect to each other;
wherein each of said two adjacent packing elements comprises a corrugated sheet and a planar sheet spirally wound together, and at least one outermost horizontal edge of said planar sheet is positioned proximal to at least one horizontal edge of said corrugated sheet.

17. The structured packing of claim 16, wherein said adjacent packing elements are arranged so that corrugations in each of said adjacent packing elements are inclined at substantially similar directions as each other.

18. The structured packing of claim 16, wherein said adjacent packing elements are arranged so that corrugations in each of said adjacent packing elements have opposite corrugation directions.

19. A method of cryogenically separating a fluid mixture in a distillation column, comprising:
forming descending liquid and ascending gaseous phases of said fluid mixture within said distillation column; and
contacting said descending liquid and ascending gaseous phases of said fluid mixture within a structured packing contained within said distillation column;
wherein said structured packing comprises a series of packing elements; each of said structured packing elements comprising a corrugated sheet and a planar sheet wound together in a spiral fashion resulting in said corrugated and said planar sheets in substantial contact with each other, and at least one outermost horizontal edge of said planar sheet is positioned proximal to at least one horizontal edge of said corrugated sheet.

20. The method of claim 19, wherein said fluid mixture comprises air, and said descending liquid phase becomes ever more concentrated in oxygen and said ascending gaseous phase becomes ever more concentrated in nitrogen.
